(19) United States
(12) Patent Application Publication
(10) Pub. No.: US 2025/0334674 A1
(43) Pub. Date: Oct. 30, 2025

(54) METHODS AND SYSTEMS FOR LONG-RANGE SIGN OR SURFACE RECOGNITION USING LIDAR

(71) Applicant: GM GLOBAL TECHNOLOGY OPERATIONS LLC, Detrolt, MI (US)

(72) Inventors: Richard Romano, Shelby Township, MI (US); Manoj K. Sharma, Troy, MI (US)

(73) Assignee: GM GLOBAL TECHNOLOGY OPERATIONS LLC, Detroit, MI (US)

(21) Appl. No.: 18/645,959

(22) Filed: Apr. 25, 2024

(51) Int. Cl. G01S 7/48; G01S 17/42; G01S 17/74

(52) U.S. Cl. CPC G01S 7/4802; G01S 17/42; G01S 17/74

(57) ABSTRACT

A method of operating a distance sensor includes emitting pulses of light from an emitter on the distance sensor at one or more designated wavelengths in a non-visible spectrum and receiving a set of reflected pulses of light with a receiver on the distance sensor that correspond to the pulses of light reflected off a surface of an object within a line-of-sight of the receiver. A point cloud is generated of an area including the surface of the object based on the set of reflected pulses of light. A pattern is identified on a surface of the object based on at least one of an area of increased or decreased reflectivity for the one or more designated wavelengths in the non-visible spectrum identified in the point cloud. Embedded data is decoded from the pattern on the surface of the object.

### INTRODUCTION

Light detection and ranging (LIDAR) are used in Autonomous Driving Systems (ADSs), Advanced Driver Assistance Systems (ADAS), and other sophisticated transport structures for sensing nearby objects. LIDAR is used in addition to cameras or radar because of its ability to generate high-resolution geometries of the environment surrounding the vehicle over a range of conditions.

### SUMMARY

Disclosed herein is a method of operating a distance sensor. The method includes emitting pulses of light from an emitter on the distance sensor at one or more designated wavelengths in a non-visible spectrum and receiving a set of reflected pulses of light with a receiver on the distance sensor that correspond to the pulses of light reflected off a surface of an object within a line-of-sight of the receiver. A point cloud is generated of an area including the surface of the object based on the set of reflected pulses of light. A pattern is identified on a surface of the object based on at least one of an area of increased or decreased reflectivity for the one or more designated wavelengths in the non-visible spectrum identified in the point cloud. Embedded data is decoded from the pattern on the surface of the object.

In another aspect of the disclosure the distance sensor includes LIDAR.

In another aspect of the disclosure the distance sensor includes a SWIR camera.

In another aspect of the disclosure the set of reflected pulses of light include a plurality of sets of reflected pulses of light that are accumulated and aligned to generate a temporal-spatial point cloud fusion.

In another aspect of the disclosure includes correlating the embedded data, or portions thereof, using information identified in a cloud storage location accessible via a network.

In another aspect of the disclosure includes conveying information from the cloud storage location to a driver using one or more of a display screen, a heads-up display, an augmented reality (AR) device, or a speaker using acoustic data.

In another aspect of the disclosure the embedded data further comprises error detection and correction code (EDC).

In another aspect of the disclosure the embedded data corresponds to at least one of a road infrastructure or a building. a sign, a building, a vest, a bridge, or another infrastructure.

In another aspect of the disclosure the embedded data corresponds to at least one of a vehicle type or a vest.

In another aspect of the disclosure includes correlating the embedded data, or portions thereof, using information identified in a look-up table stored on a vehicle in real-time.

In another aspect of the disclosure the pattern is generated by at least one of a chemical treatment or a retroreflector on the surface of the object.

A system includes a distance sensor having an emitter and a receiver and a controller in communication with the distance sensor. The controller is configured to direct the emitter to emit pulses of light at one or more designated wavelengths in a non-visible spectrum and direct the receiver to receive a set of reflected pulses of light that correspond to the pulses of light reflected off a surface of an object within a line-of-sight of the receiver. The controller is also configured to generate a point cloud of an area including the surface of the object based on the set of reflected pulses of light and identify a pattern on a surface of the object based on at least one of an area of increased or decreased reflectivity for the one or more designated wavelengths in the non-visible spectrum identified in the point cloud.

In another aspect of the disclosure the controller is configured to decode embedded data from the pattern on the surface of the object based on information from at least one of a look-up table or a cloud storage location accessible via a network.

In another aspect of the disclosure the information includes at least one of a color or text on the object.

In another aspect of the disclosure the set of reflected pulses of light include a plurality of sets of reflected pulses of light and the controller is configured to accumulate and align the plurality of sets of reflected pulses of light to generate a temporal-spatial point cloud fusion.

In another aspect of the disclosure the pattern corresponds to at least one of a road infrastructure or a building. a sign, a building, a vest, a bridge, or another infrastructure.

In another aspect of the disclosure the pattern corresponds to at least one of a vehicle type or a vest.

In another aspect of the disclosure the pattern is generated by at least one of a chemical treatment or a retroreflector on the surface of the object.

Disclosed herein is a vehicle. The vehicle includes a body defining a passenger compartment and supported by wheels, a distance sensor having an emitter and a receiver, and a controller in communication with the distance sensor. The controller is configured to direct the emitter to emit pulses of light at one or more designated wavelengths in a non-visible spectrum and direct the receiver to receive a set of reflected pulses of light that correspond to the pulses of light reflected off a surface of an object within a line-of-sight of the receiver. The controller is also configured to generate a point cloud of an area including the surface of the object based on the set of reflected pulses of light and identify a pattern on a surface of the object based on at least one of an area of increased or decreased reflectivity for the one or more designated wavelengths in the non-visible spectrum identified in the point cloud.

In another aspect of the disclosure the controller is configured to decode embedded data from the pattern on the surface of the object.

The above summary is not intended to represent every embodiment or every aspect of the present disclosure. Rather, the foregoing summary merely provides examples of some of the novel concepts and features set forth herein. The above features and advantages, and other features and attendant advantages of this disclosure, will be readily apparent from the following detailed description of illustrated examples and representative modes for carrying out the present disclosure when taken in connection with the accompanying drawings and the appended claims. Moreover, this disclosure expressly includes the various combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a plan view illustration of a vehicle and a battery system coupled to an Electronic Control Unit (ECU) and a power inverter module (PIM) in which the principles of the present disclosure may be implemented.

FIG. 2 is a conceptual diagram of a technique for embedding a street sign having a visible message with encoded digital data in an infrared spectrum using chemical coatings and selective retroreflectors to produce a sign having the visible message along with the invisible digital data encoded therein.

FIG. 3 is a diagram of a sign with an angle used for embedding micro QR codes on object surfaces such as traffic signs based at least in part on specifications from the Manual on Uniform Traffic Control Devices (MUTDC).

FIG. 4 is an example of selective retroflecting techniques for encoding digital data on surfaces such that light reflected off a point follows a reflective direction in which the incident light was transmitted.

FIG. 5 is an example of a vest object embedded selectively on a rear surface with digital data in accordance with an embodiment.

FIG. 6 is a contextual flow diagram identifying the methods for creating the digitally encoded surface along with the regions or layers in which the steps of the methods are performed.

The appended drawings are not necessarily to scale and may present a simplified representation of various features of the present disclosure as disclosed herein, including, for example, specific dimensions, orientations, locations, shapes, and scale. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

The present disclosure introduces systems, vehicles, and methods that take advantage of distance sensors, such as LIDAR or SWIR, to recognize embedded readable information in signs or on the surfaces of other objects, such as road markings, other road users (e.g., construction workers), commercial-based signs (e.g., restaurant signs near the roadway), and the like. The embedded information is readable by distance sensors that operate in a non-visible light spectrum, such as LIDAR or SWIR. While the principles of the disclosure apply to such information embedded on the surface of many types of objects on, over or otherwise adjacent a roadway used by vehicles, implementations of the present disclosure often use signs, such as road signs, in connection with their example for simplicity. However, this disclosure is applicable to areas other than road signs, such as clothing or other vehicles.

Each sign's coating is enhanced to allow for specific geometric regions of the sign to reflect particular wavelengths of light, such as wavelengths of light outside of the visible spectrum. These geometric regions may be used to embed digital information that the distance sensor(s) on a vehicle or other transport structure to detect and decode to extract information beyond the mere visible words of the sign; such as the sign's type, purpose, and details correlating the visible words with other data that may be conveyed to a user or driver of a vehicle by means of a microcontroller unit (MCU) or plurality of MCUs in the vehicle (often referred to as a processing system having one or more cores, cache memory, and dynamic memory, or other types of memory such as read only memory, for example).

In one configuration, one or more distance sensors, such as LIDAR or SWIR, are affixed to the vehicle, e.g., via the frame or other location. When in the line of sight (LOS) of the sign or surface of another object (roadway markers implanted to demarcate lanes on the road, for example, an officer's vest, etc.), the LIDAR and SWIR sensors on the vehicle are able to capture additional information beyond the words on the sign—that is, the driver's reading of the sign in the visible spectrum (e.g., “slow ahead”) or the vehicle's capturing of the sign's words using one or more visible-wavelength cameras integrated into the vehicle. The encoded digital information in the sign is in one or more, or a range, of infrared wavelengths, and as such, is advantageously invisible to the driver, thereby avoiding clutter. In some examples, the digital information includes error detection and correction data (EDC) so that the processing system in the vehicle may properly encode the information obtained from the LIDAR and the SWIR sensors mounted thereon. The geometric regions in which the surface of the object is implemented using different methods that convey digital information. While one such example is a standard QR-code, numerous other information formats may be used. The infrared wavelengths may be in one or more, or a range or, wavelengths, and the corresponding vehicle's distance sensors may be tuned to those wavelengths so that they may successfully extract the embedded digital data. In one example, the embeddings are formed by using specific chemical coatings to write the LIDAR readable codes, such as a multilayer of ZnS/Ge for wavelength selective emission. The chemical coatings may be used, such that at a given point on the surface of the sign or object, the coating may either increase or decrease the reflectivity of the emitted waves of the distance sensor at a specific wavelength. When a distance sensor emits light pulses in the applicable infrared spectrum, the distance sensor may identify the geometric regions with the embedded information using the reflected infrared light and its relative increases/decreases from a baseline.

In other configurations, in addition to using the chemical coatings described above to embed the digital data, wavelength selective retroreflectors may be used as discussed below with respect to FIG. 4. One feature of the selective retroreflectors is that the infrared light emitted by the distance sensor, when received at the surface of the sign, is reflected back to the distance sensor at an angle that matches the angle of incidence. The result is that, when augmenting the signs with retroreflectors, the distance sensor may be able to see the reflected infrared light from much farther away, since the infrared light will be reflected on an axis parallel to the axis at which the infrared light arrived from the distance sensor. In short, by enabling the distance sensor to detect the reflected light from a farther distance, the readings of the digital data by the sensors (or by the MCU(s)/processing system coupled to the sensors) may be made far more accurate. The embedded digital codes on the surface of the sign/object may therefore provide close to ground truth levels of accuracy similar to those of fiducial markers for cameras when decoded.

Various embodiments of systems and methods to augment existing signs, road users and roadway infrastructure with specific information that may be accurately read by a distance sensor, and similar systems without changing the appearance of the sign's surface in the visible light band are disclosed. The methods enable distance sensors mounted on or affixed to the vehicle to capture additional environmental information including the meaning of signs and to classify other road users. The methods may employ specific data codes to augment traffic and informational signs, vehicles, and vests for distance sensor recognition. Some configurations further include error detection and correction data embedded in the codes to ensure accurate data extraction. As noted, the information may be embedded using wavelength selective retroreflectors or chemical coatings to write distance sensor readable codes. The coating can either increase or decrease retro reflectivity at a specific wavelength.

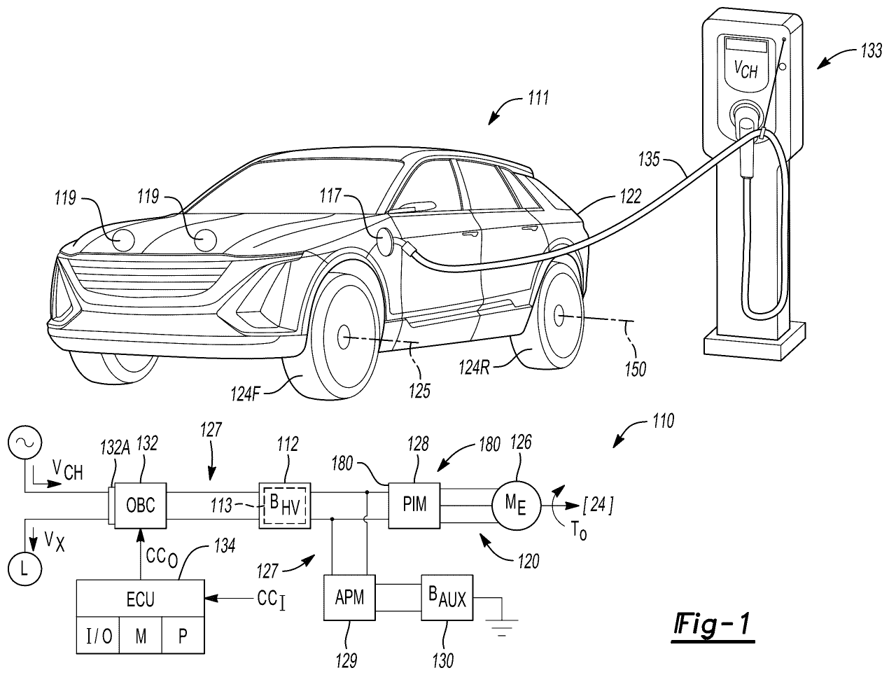

While the principles of the present disclosure have wide application to diverse architectures involving infrared reading and decoding of embedded digital information on object surfaces, for purposes of example, electric vehicles (EVs) are considered. It should be understood, however, that the distance sensors may be affixed to other types of transports structures (such as, for example, snowblowers, garbage trucks, cargo trucks, low-flying aircraft, and the like). In one such configuration, FIG. 1 is a plan view illustration of a vehicle and a battery system coupled to an Electronic Control Unit (ECU) and a power inverter module (PIM) in which the principles of the present disclosure may be implemented. In the embodiment of FIG. 1, an ECU performs the calibration internal to the vehicle. Advantageously, whenever it is deemed that the calibration has been decayed for whatever reason, or even on power-on, the ECU may apply the principles of the present disclosure to recalibrate each camera on the vehicle, including the distance sensors 119 mounted on the body of the vehicle, the rear of the vehicle, or elsewhere. That is to say, calibration may be performed on the vehicle using the described on-board electronics.

While an electric vehicle is shown in FIG. 1, it will be appreciated that the disclosure is not so limited and that the internal calibration procedures may be performed by each vehicle having the appropriate programmed circuitry. While the above hysteresis models may apply to a number of different physical configurations, FIG. 1 shows one such example. FIG. 1 depicts an electrified powertrain system 110 having a high-voltage battery pack (B_{HV}) 112 for which SOC estimations may be made. In a non-limiting example, the battery pack 112 may be embodied as a high-capacity battery having a voltage capability of about 400-800 volts or more, with the actual voltage capability of the battery pack 112 provided based on a desired operating/SOC range, gross weight, and power rating of a load connected to the battery pack 112. In a possible construction, the battery pack 112 may be a propulsion battery pack generally composed of an array of lithium-ion or lithium-ion polymer rechargeable electrochemical battery cells, which may be a cylindrical battery cell. The present teachings may also be applied to prismatic battery cells, and to pouch-style battery cells in configurations, and thus the cylindrical battery cell is exemplary without being limiting.

Although internal details of the battery cells in battery pack 112 are omitted for illustrative simplicity, those skilled in the art will appreciate that the battery cells contain within the cell cavity an electrolyte material, working electrodes in the form of a cathode and an anode, and a permeable separator (not shown), which are collectively enclosed inside an electrically-insulated can or casing. Grouped battery cells may be connected in series or parallel through use of an electrical interconnect board and related buses, sensing hardware, and power electronics (not shown but well understood in the art). An application-specific number of the battery cells in battery pack 112 may be arranged relative to the battery tray 113 in columns and rows. In a nominal “xyz” Cartesian reference frame, for instance, the battery tray 113 when viewed from above or below may have a length (x-dimension) and a width (y-direction), with a height (z-dimension) extending in an orthogonal direction away from the battery tray 113.

In a representative use case, the electrified powertrain system 110 may be used as part of an EV 111 or another mobile system. As shown, the EV 111 may be embodied as a battery electric vehicle, with the present teachings also being extendable to plug-in hybrid electric vehicles. Alternatively, the electrified powertrain system 110 may be used as part of another mobile system such as but not limited to a rail vehicle, aircraft, marine vessel, robot, farm equipment, etc. Likewise, the electrified powertrain system 110 may be stationary, such as in the case of a powerplant, hoist, drive belt, or conveyor system. Therefore, the electrified powertrain system 110 in the representative vehicular embodiment of FIG. 1 is intended to be illustrative of the present teachings and not limiting thereof.

The EV 111 shown in FIG. 1 includes a vehicle body 122. The vehicle body 122 may include a frame within the body 122 to define areas for placement of mechanical and electrical components, as well as a passenger cabin. The EV may further include road wheels 124F and 124R, with “F” and “R” indicating the respective front and rear positions. The road wheels 124F and 124R rotate about respective axes 125 and 150, with the road wheels 124F, the road wheels 124R, or both being powered by output torque (arrow To) from a rotary electric machine (M_{E}) 126 of the electrified powertrain system 110 as indicated by arrow [24]. The road wheels 124F and 124R thus represent a mechanical load in this embodiment, with other possible mechanical loads being possible in different host systems. To that end, the electrified powertrain system 110 includes a power inverter module (PIM) 128 (also referenced herein as a power module (PM)) and the high-voltage battery pack 112, e.g., a multi-cell lithium-ion propulsion battery or a battery having another application-suitable chemistry, both of which are arranged on a high-voltage DC bus 127. As appreciated in the art, the PIM 128 includes a DC side (180) and an alternating current (AC) side 120, with the latter being connected to individual phase windings (not shown) of the rotary electric machine 126 when the rotary electric machine 126 is configured as a polyphase rotary electric machine in the form of a propulsion or traction motor as shown.

The battery pack 112 of FIG. 1 in turn is connected to the DC side 180 of the PIM 128, such that a battery voltage from the battery pack 112 is provided to the power inverter module (PIM) 128 during propulsion modes of the EV 111. The PIM 128, or more precisely a set of semiconductor switches (not shown) residing therein, are controlled via pulse width modulation (PWM), pulse density modulation (PDM), or other suitable switching control techniques to invert a DC input voltage on the DC bus 127 into an AC output voltage suitable for energizing a high-voltage AC bus 120. As noted, the PIM 128 may also be referred to simply as a power module (PM), which may include an inverter or converter. High-speed switching of the resident semiconductor switches of the PIM 128 energizes the rotary electric machine 126 to thereby cause the rotary electric machine 126 to deliver the output torque (arrow To) as a motor drive torque to one or more of the road wheels 124F and/or 124R in another coupled mechanical load in other implementations.

Electrical components of the electrified powertrain system 110 may also include an accessory power module (APM) 129 and an auxiliary battery (B_{AUX}) 130. The APM 129 is configured as a DC-DC converter that is connected to the DC bus 127, as appreciated in the art. In operation, the APM 129 is capable, via internal switching and voltage transformation, of reducing a voltage level on the DC bus 127 to a lower level suitable for charging the auxiliary battery 130 and/or supplying low-voltage power to one or more accessories (not shown) such as lights, displays, etc. Thus, “high-voltage” refers to voltage levels well in excess of typical 12-15V low/auxiliary voltage levels, with 400V or more being an exemplary high-voltage level in some embodiments of the battery pack 112.

In some configurations, the electrified powertrain system 110 of FIG. 1 may include an on-board charger (OBC) 132 that is selectively connectable to an offboard charging station 133 via an input/output (I/O) block 132A during a charging mode during which the battery pack 112 is recharged by an AC charging voltage (V_{CH}) from the offboard charging station 133. The I/O block 132 is connectable to a charging port 117 on the vehicle body 122. For instance, a charging cable 135 may be connected to the charging port 117, e.g., via an SAE J1772 connection. The electrified powertrain system 110 may also be configured to selectively receive a DC charging voltage in one or more embodiments as appreciated in the art, in which case the OBC 132 would be selectively bypassed using circuitry (not shown), e.g., that may be used to charge and/or discharge the battery pack 112 gradually for performing various functions, such as testing the SOC. The OBC 132 could also operate in different modes, including a charging mode during which the OBC 132 receives the AC charging voltage (VCH) from the offboard charging station 133 to recharge the battery pack 112 after a low charge indicator light displays on the dashboard, and a discharging mode, represented by arrow Vx, during which the OBC 132 offloads power from the battery pack 112 to an external AC electrical load (L). In this manner, the OBC 132 may embody a bidirectional charger.

Still referring to FIG. 1, the electrified powertrain system 110 may also include an electronic control unit (ECU) 134. The ECU 134 is operable for regulating ongoing operation of the electrified powertrain system 110 via transmission of electronic control signals (arrow CC_{O}). The ECU 134 does so in response to electronic input signals (arrow CC₁). Such input signals (arrow CC₁) may be actively communicated or passively detected in different embodiments, such that the ECU 134 is operable for determining a particular mode of operation. In response, the ECU 134 controls operation of the electrified powertrain system 110. Thus, the ECU and its accompanying components may act as a BMS for performing functions including estimating the SOC, etc.

To that end, the ECU 134 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described SOC functionality in prior figures, as well as different functions identified by the CC input signal. The ECU 134 also includes an associated computer-readable storage medium, i.e., memory (M) inclusive of read only, programmable read only, random access, a hard drive, etc., whether resident, remote or a combination of both. Control routines, including code for executing the SOC model with hysteresis, are executed by the processor to monitor relevant inputs from sensing devices and other networked control modules (not shown), and to execute control and diagnostic routines to govern operation of the electrified powertrain system 110. The I/O circuits may be directly coupled to the ECU 134, along with memory M and one or more processors P for executing code that estimates SOC. In an aspect, the BMS system may collectively be realized as ECU 134, OBC 132 and bus 127. OBC 132 and bus 127 may be an apparatus within the BMS, or included as part of the BMS that is enabled to be connected to the outer terminals of battery pack 112 to perform the functions recited herein. In some implementations, the BMS may be coupled directly with the battery pack.

EV 111 may, like other vehicles, include a dashboard implanted within or otherwise connected to the body of EV 111. The body houses a cabin where the driver and occupants reside. The apparatus discussed above may include control signals to the dashboard and conversion circuitry to enable the driver to assess the SOC remaining based on an amount or percentage of charge remaining, an estimated time that the vehicle will die or imminently needs recharging, and other data. At least some of these aspects may be computed by the BMS, including ECU 134 and its associated processor P running code from memory M. Messages may be sent via the I/O circuit to other parts of the vehicle, via CC₀ or another connection not specifically shown.

In another embodiment, ECU 134 along with its I/O, memory and processor may additionally or alternatively be used to calibrate and recalibrate each of the cameras in the EV, or selected ones. In this case, the flow diagrams, such as the flow diagram 600, may be run on the processor and the ECU 134 may be appropriately connected to carry out calibrations for each of the cameras. This may occur during suspected miscalibrations caused by force events, or it may simply be recalibrated every X times the driver turns on the EV 111. It should be noted again that another type of combustion based, or hybrid vehicle may be used in this embodiment. This embodiment also obviates the expensive and time-consuming need to implement calibrations independently for each of the vehicles at startup. ECU 134 may be coupled to each of the cameras via a hardwire or networked connection, or it may be connected to selected cameras.

In the above example, the PIM 128 (or more simply, the PM) may include a set of semiconductor switches driven by a modulation technique such as PWM (although other suitable modulation techniques such as PDM may be used). In other configurations, the ECU or a microcontroller unit (MCU) therein (e.g., processor P) may also be used to govern the transmission of modulated signals. The semiconductor switches of PIM 128 may include power transistors, and the modulation technique used to drive them may include intermediary circuitry to suitably decode the PWM signals and to adjust the rail-to-rail voltage swing from power used by logic circuits (e.g., 0 to 5 volts, or the like) to the higher voltages needed by a gate driver to switch the power transistors that drive the rotary electric machine 126. With reference the PIM 128, a gate driver may be employed to turn the power transistors/switches on and off.

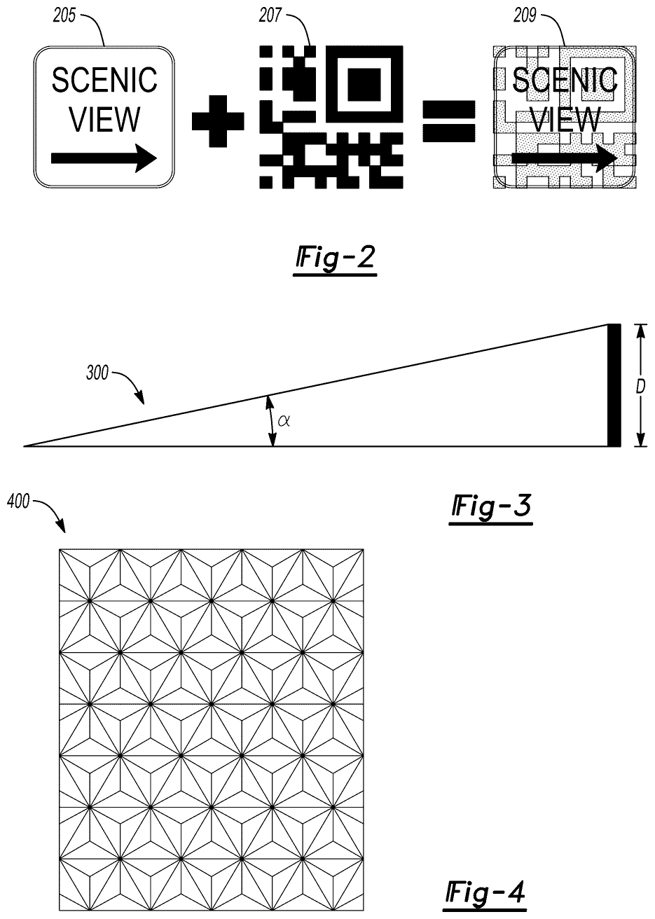

FIG. 2 is a conceptual diagram of a technique for embedding a street sign having a visible message with encoded digital data in an infrared spectrum using chemical coatings and selective retroreflectors to produce a sign having the visible message along with the invisible digital data encoded therein. Initially it should be noted that, for the purposes of the initial sign 205 that reads for exemplary purposes “Scenic View,” the Department of Transportation has promulgated a series of specifications including in the form of a Manual on Uniform Traffic Control Devices (MUTDC).

Referring back to FIG. 2, a sign 205 with the words “Scenic View” may be created for example purposes. Further shown for conceptual purposes is a random quick-response-code (QR-code) 207. To accomplish the objectives of this disclosure, it may be desirable to include QR-code 207 (possibly along with other digital embedded codes) on the surface of the sign 205. Using the chemical coating techniques and optionally, the selective retroreflector techniques described above, the QR-code 207 is embedded in this example on the surface of the sign 209. While the QR-code 207 is shown on the sign 209 to demonstrate that the digitally-embedded data is now available, in actuality the QR-code 207 is etched in infrared wavelengths. Consequently, the sign “Scenic View” 205 with the corresponding arrow remains unimpeded and is easily read by the driver (and in some cases, a visible camera or sensor affixed on the vehicle and coupled with the processing system), the distance sensors may then use the tuned infrared wavelengths to acquire the information in the QR-code 207. In some cases, the data may be directly relevant to the visible content of the sign. Thus the processing system on the vehicle (which may include the MCU, or one or more (or a network) of electronic control units (ECUs), each equipped with MCUs) may decode the data and where needed, the processing system may convey the embedded data to the driver of the vehicle, e.g., via a display screen, heads-up display, augmented reality (AR) device or display, etc. The processing system may also convey the details acoustically over speakers in the vehicle. The digital data may pertain to more details about the “scenic view,” such as areas to park, areas of danger, and the like.

The principles of FIG. 2 represent one simple example of a large number of applications that may be used in connection with the distance sensor capabilities of the vehicle or structure at issue. A large number of applications may be contemplated for communicating data to the processing system of the moving vehicle, whether or not the data is specifically correlated with the visible information on the sign or other surface of an object (e.g., a side of a bridge near the roadway, a surface of an establishment near the roadway, etc. In other cases, the embedded infrared-based information may enable the distance sensors on the vehicle to capture additional environmental information, including the meaning of signs, to classify other road users (e.g., construction staff, authorities, etc.), and to perform other actions. In real applications, there may be different distance sensors, each pointing in the same, different and/or overlapping directions. Different distance sensors on the vehicle may also be tuned to different wavelengths. For example, one distance sensor may use 900 nm while another uses 1300 nm. The sign may reflect at either or both wavelengths.

FIG. 3 is a diagram of a sign with an angle α used for embedding micro QR codes on object surfaces such as traffic signs based at least in part on specifications from the (MUTDC). When constructing a visible sign (such as the sign with length D in FIG. 3), the designers may take into account various criteria, such as the minimum distance that the sign may be seen by a driver of a moving vehicle, the size of the letters and numbers on the sign as discussed above, the colors of the sign, and other criteria. These criteria may include, for example, the requirements and specifications in the MUTCD, which may enunciate minimum sign legibility distances of 180 to 250 feet. While warning signs may be a range of sizes depending on the application and circumstances, 36×36 inch signs are assumed here for simplicity. Other criteria that may be relevant to the design of the system include the influence of rain and fog on LIDAR performance. Based on current recommendations, it may be assumed for a metal warning sign at highway speed the existence of the same number of points on target in 40 millimeters/hour (1.57 inches/hour) of rain at 180 feet (horizontal distance) as at 250 feet in sunny conditions. In addition, resolution varies depending on the distance sensor used. For example, LIDAR currently has a resolution of approximately 0.05 degrees and a SWIR camera currently has a resolution of approximately 0.015 degrees.

Referring back to FIG. 3, one embodiment of a solution in which micro QR-codes 207 are embedded on traffic signs is disclosed. The traffic sign may have a length of D. In an example, D=3 feet and traffic sign has a square form factor of 3 feet×3 feet. For simplicity, the configuration in FIG. 3 may include a 250 foot detection distance which may be the distance between a moving vehicle currently positioned at the leftmost side of triangle 300. The symbol α may represent the degrees that enable the moving vehicle at the above position to perform the detection. In one example, α=0.67 degrees. The information about the sign type may be encoded onto the traffic sign using rectangles that make up the sign. For example, using MUTCD specifications, the sign may be partitioned into thirteen 3 inch by 3 inch encoding squares. Each encoding square may use different data formats. For example, some encoding squares may use QR codes. Other encoding squares (or other signs) may use AprilTags, which is another system of encoding digital content using unique descriptors. In this example, digital encoding is used because it allows for error reduction or elimination by using EDC, for example.

FIG. 4 is an example of selective retroflecting techniques for encoding digital data on surfaces such that light reflected off a point follows a reflective direction in which the incident light was transmitted. As noted above, selective retroreflecting techniques may be used for retroreflecting infrared light at a particular wavelength or within a wavelength range while remaining invisible and not obscuring visible light from signs or other object surfaces. In FIG. 4, the pattern 400 represents a portion of a multilayer coating. A wavelength selective reflecting dielectric layer (or plurality of layers) may be strategically coated on an existing retroreflector, such as an array of cube corners. The thickness of the layers may be varied to determine the wavelength(s) that may be reflected selectively. An additional advantage of this technique is that selective retroreflection further allows the reflecting infrared light to be reflected along the same axis in which the light was initially transmitted. This phenomenon increases the accuracy of the code-reading since the reflected intensity onto the distance sensors will be greater.

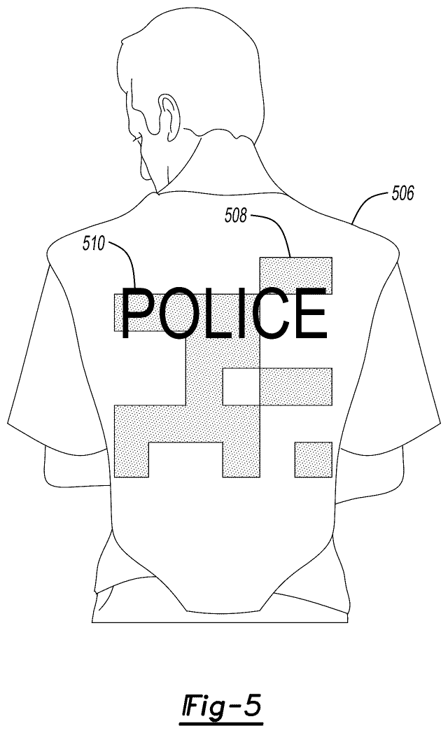

FIG. 5 is an example of a vest object embedded selectively on a rear surface with digital data in accordance with an embodiment. The vest 506 of an officer's jacket may have the designation “Police” 510, for example. An example QR-code 508 has been overlaid using chemical coatings, potentially with additional selective retroreflectors. The vest may also use high-visibility colors to enhance the officer's visibility. These colors are not obscured by the infrared digitally embedded information (e.g., QR-code 508). Thus, if the officer is on the roadway tending to an accident, the distance sensors 119 affixed to an approaching vehicle may read the digitally embedded information, which is transferred to the processing system (e.g., the MCU) for decoding and potentially conveying to the user. The data on the vest may signify information about the officer's identity, the officer's role, or instructions to a driver for negotiating the obstacle that lay ahead. In one example, a sign may be posted one mile ahead of road closure that informs the vehicle that the left lane is currently available. This information may advantageously be integrated with the GPS information or vehicle mapping information to update the vehicle's route.

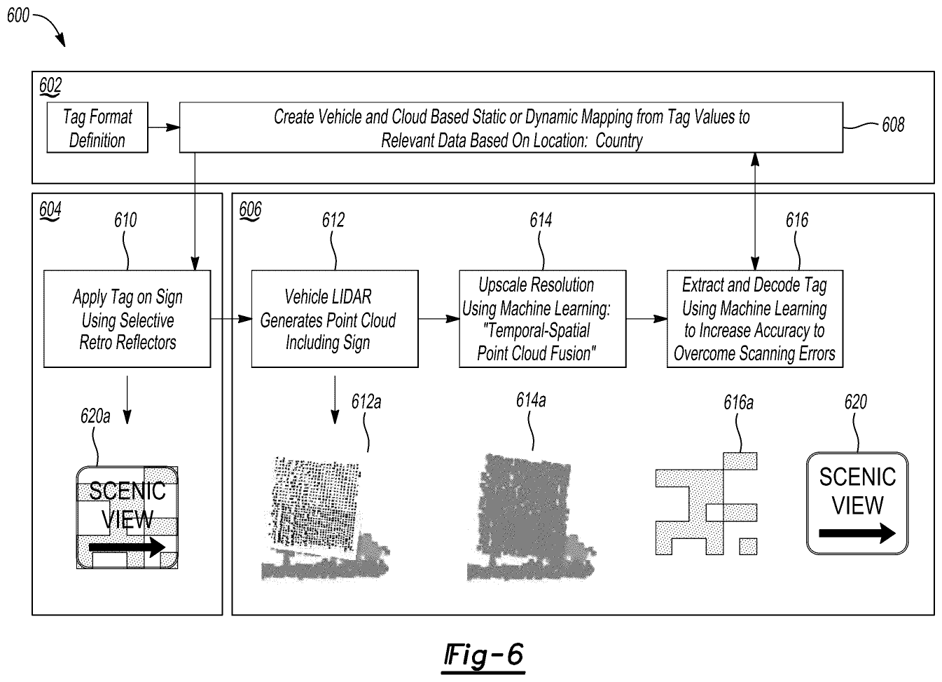

FIG. 6 is a contextual flow diagram 600 identifying the methods for creating the digitally encoded surface along with the regions, layers or environment in which the steps of the methods are performed. Logic block 602 represents that the steps in that block are cloud-based. That is, they are securely creating using processing and storage resources assigned to the manufacturer of the sign. The information is secure and encrypted. The cloud-based logic block 602 first identifies that the designers may select, using appropriate applications over the cloud, a tag format definition. Examples that have been described include QR-codes and Apriltags. However, current or future tag format may also be possible and equally suitable for purposes of this disclosure. Thereupon, having the tag format definition in place, the cloud-based application may be used to create vehicle and cloud based static or dynamic mapping from tag values to relevant data based on different factors. One such important factor is the location of the anticipated configuration, e.g., the United States. Accordingly, in the creation process of the tag, relevant DOT specifications may be consulted to identify various significant data relevant to the QR-tag or the context such as its identity, links to the data (e.g., over the cloud or local), and the like.

Following the arrow from step 608 to step 610, the latter step is resident in logic block 604, which represents the physical infrastructure—e.g., the application of the tag on the sign. In this example at step 610, the tag is applied on the sign using at least one of chemical coatings or selective retroreflectors. The result is the sign 620a with the invisible, overlaid QR-tag. Accordingly, logic blocks 602 and 604 represent preliminary phenomena that take place to properly embed information in the signs. In other embodiments, more complex signs with more sophisticated tag formats may be used.

Logic block 606 represents illustrations of the steps that occur within the vehicle when the distance sensors 119 affixed on the vehicle gather information from their emitted infrared pulses and send that information to the processing system for decoding, error correction, and other procedures. In the configurations described, the vehicle is configured to travel along a roadway and approach the sign 620a. As such, the distance sensors that are within the line of sight of the surface of the sign 620a take multiple point clouds and aggregate them for increased accuracy. At step 612, a distance sensor on the moving vehicle within the LOS of sign 620a generates a point cloud at an instant in time after emitting infrared pulses at the sign. A point cloud is generated when the area (here, the surface of sign 620a) is scanned using the laser light pulses from the distance sensor's emitter, and the reflected light pulses in the relevant infrared wavelength(s) or range thereof is returned to the a receiver on the distance sensor, thereby creating data at certain specific points in a Cartesian coordinate system. Because the distance sensor is being propelled forward by the motion of the vehicle, the distance sensor generates a point cloud in step 612 including the surface of sign 620a, as shown in illustration 612a. The process continues at 614, where the distance sensor may advantageously use machine learning techniques to upscale or increase the resolution of the object scanned, including the sign and tag. Thus, the resolution of the point cloud may be upscaled using machine learning in a procedure called “temporal-spatial point cloud fusion,” shown in illustration 614a. Here, as noted, multiple point clouds are continuously taken and are then aligned in time and space (e.g., by the processing system) to create the fused point cloud, which provides assurance that as much of the tag is captured as possible. The tag is thereafter extracted from the final fused point cloud as shown in illustrations 616a and 620, from which the digital data is retrieved and decoded. In some implementations, as shown by the bidirectional arrow between step 616 and step 608, whereby the decoded tag is used to access information in the cloud-based logic block 602, such as by a cellular network, Wi-Fi network, proprietary wireless network or other network connection. The tag may then beneficially be associated with a corresponding meaning, set of values, color of the object and text associated with the object, or other criteria. In other configurations, the tag may be passed to another ECU in the vehicle wherein a database resides that enables the designer to associate the tag with other data stored within the vehicle itself in real time, such as by using a look-up table of tags and associated data, such as color of the object and text associated with the object. Thereafter, depending on the implementation, the tag may use the cloud-based data or vehicular data to control some other part of the vehicle, such as in the case of an ADS. In other configurations, the information associated with the tag may be transmitted via a display or via speakers to a driver or occupants of a vehicle.

The principles of the disclosure have significant benefits in applications that include both autonomous vehicles and existing driven vehicles. For the former, the roadways may be populated with numerous tags embedded on various surfaces from which digital tags are extracted and decoded. Where necessary, the processing system of the vehicle may access other sources to obtain further details relevant to the tag or its meaning. These procedures may be performed in real-time to thereby enable the embedded tags to control the motion (including speed and braking) of the vehicle. In vehicles involving an active driver, the benefits further extend to the invisibility of the embedded tags to the driver. Clutter or data pollution is thereby avoided as the driver clearly sees the sign via standard colors in the visible spectrum, while the tag data is hidden in infrared wavelengths and therefore does not represent a distraction to the driver.

It should be noted that, while the micro-controller unit (MCU) may be the MCU integrated into a dedicated ECU or network thereof, for purposes of this disclosure, the terms “MCU” and “processor” may constitute more than one processor. The terms may refer to each kind of controller or microcontroller for executing various tasks enumerated in this disclosure, including the analysis and modification of SRs, current sharing, reduction in dead. In some cases, at least part of the processor may include dedicated hardware, such as in a digital signal processor (DSP). The processor may also be implemented (in part or in full) with an application specific integrated circuit (ASIC), a System on a Chip (SoC), combinational Boolean logic circuits that perform the requisite digital functions, a field-programmable gate array (FPGA) Application Specific Integrated Circuits (ASICs), or another type of programmable logic device (PLD). The transistors used in the processor may include complementary metal-oxide-semiconductor (CMOS) technology, bipolar junction transistors, Gallium-Arsenide transistors, or some combination thereof. The processor may execute middleware, and in some embodiments, it may rely at least partially on one or more application programming interfaces to communicate with other systems. The processor may also include upgradeable firmware. The memory may be logically partitioned to include a database or repository, or relational or non-relational data tables.

The processor may be part of a processing system. The processing system may include memory (e.g., various levels of cache memory, dynamic random access memory (DRAM), static random access memory (SRAM), programmable read only memory (PROM), electrically erasable programmable read-only memory (EEPROM or EPROM), flash memory, magneto-based hard drives, solid state hard drives, and the like. The memories may include code stored therein and data. The collective structural and functional architecture of the processing system is intended to simplify the parlance and to acknowledge that the code may be executed using processors at separate locations, for example or in several diverse ways, just a few of which are described above.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented herein.

What is claimed is:

1. A method of operating a distance sensor, the method comprising:
emitting pulses of light from an emitter on the distance sensor at one or more designated wavelengths in a non-visible spectrum;
receiving a set of reflected pulses of light with a receiver on the distance sensor that correspond to the pulses of light reflected off a surface of an object within a line-of-sight of the receiver;
generating a point cloud of an area including the surface of the object based on the set of reflected pulses of light;
identifying a pattern on a surface of the object based on at least one of an area of increased or decreased reflectivity for the one or more designated wavelengths in the non-visible spectrum identified in the point cloud; and
decoding embedded data from the pattern on the surface of the object.

2. The method of claim 1, wherein the distance sensor includes a LIDAR.

3. The method of claim 1, wherein the distance sensor includes a SWIR camera.

4. The method of claim 1, wherein the set of reflected pulses of light include a plurality of sets of reflected pulses of light that are accumulated and aligned to generate a temporal-spatial point cloud fusion.

5. The method of claim 1, including correlating the embedded data, or portions thereof, using information identified in a cloud storage location accessible via a network.

6. The method of claim 5, including conveying information from the cloud storage location to a driver using one or more of a display screen, a heads-up display, an augmented reality (AR) device, or a speaker using acoustic data.

7. The method of claim 1, wherein the embedded data further comprises error detection and correction code (EDC).

8. The method of claim 1, wherein the embedded data corresponds to at least one of a road infrastructure or a building. a sign, a building, a vest, a bridge, or another infrastructure.

9. The method of claim 1, wherein the embedded data corresponds to at least one of a vehicle type or a vest.

10. The method of claim 1, including correlating the embedded data, or portions thereof, using information identified in a look-up table stored on a vehicle in real-time.

11. The method of claim 1, wherein the pattern is generated by at least one of a chemical treatment or a retroreflector on the surface of the object.

12. A system comprising:
a distance sensor having an emitter and a receiver;
a controller in communication with the distance sensor, the controller configured to:
direct the emitter to emit pulses of light at one or more designated wavelengths in a non-visible spectrum;
direct the receiver to receive a set of reflected pulses of light that correspond to the pulses of light reflected off a surface of an object within a line-of-sight of the receiver;
generate a point cloud of an area including the surface of the object based on the set of reflected pulses of light; and
identify a pattern on a surface of the object based on at least one of an area of increased or decreased reflectivity for the one or more designated wavelengths in the non-visible spectrum identified in the point cloud.

13. The system of claim 12, wherein the controller is configured to decode embedded data from the pattern on the surface of the object based on information from at least one of a look-up table or a cloud storage location accessible via a network.

14. The system of claim 13, wherein the information includes at least one of a color or text on the object.

15. The system of claim 12, wherein the set of reflected pulses of light include a plurality of sets of reflected pulses of light and the controller is configured to accumulate and align the plurality of sets of reflected pulses of light to generate a temporal-spatial point cloud fusion.

16. The system of claim 12, wherein the pattern corresponds to at least one of a road infrastructure or a building. a sign, a building, a vest, a bridge, or another infrastructure.

17. The system of claim 12, wherein the pattern corresponds to at least one of a vehicle type or a vest.

18. The system of claim 12, wherein the pattern is generated by at least one a chemical treatment or a retroreflector on the surface of the object.

19. A vehicle, comprising:
a body defining a passenger compartment and supported by a plurality of wheels;
a distance sensor having an emitter and a receiver;
a controller in communication with the distance sensor, the controller configured to:
direct the emitter to emit pulses of light at one or more wavelengths in a non-visible spectrum;
direct the receiver to receive a set of reflected pulses of light that correspond to the pulses of light reflected off a surface of an object within a line-of-sight of the receiver;
generate a point cloud of an area including the surface of the object based on the set of reflected pulses of light; and
identify a pattern on a surface of the object based on at least one of an area of increased or decreased reflectivity for the one or more wavelengths in the non-visible spectrum identified in the point cloud.

20. The vehicle of claim 19, wherein the controller is configured to decode embedded data from the pattern on the surface of the object.
